(19) United States
(12) Patent Application Publication
(10) Pub. No.: US 2001/0050895 A1
(43) Pub. Date: Dec. 13, 2001

(54) Optical pickup having an optical path difference adjusting unit

(76) Inventor: Man-Hyung Lee, Seoul (KR)

Correspondence Address: BIRCH STEWART KOLASCH & BIRCH, PO BOX 747, FALLS CHURCH, VA, 22040-0747, US

(21) Appl. No.: 09/878,397

(22) Filed: Jun. 12, 2001

(30) Foreign Application Priority Data
Jun. 12, 2000 (KR) 32184/2000

(51) Int. Cl. G11B 7/135

(52) U.S. Cl. 369/112.16

(57) ABSTRACT

An optical path difference compensation means of a birefringence material: Which transmits incident lights having different wavelength and compensates a phase of the incident light to decrease aberration of one of said incident lights without affecting the other incident light.

In this case, the compensated incident light has a longer wavelength than the other. Further, the incident light are polarized light.

### BACKGROUND OF THE INVENTION

1. Field of the Invention

The present invention relates to an optical pickup having an optical path difference adjusting unit, which enables data to be reproduced/recorded from/on discs of different kinds having different thicknesses by means of a single optical pickup, and in which an aberration of the light beam focused on the disc can be compensated by adjusting an optical path difference of an incident light beam. More particularly, the present invention relates to an optical pickup having an optical path difference adjusting unit, in which a difference of working distance from an objective lens to discs of different kinds is decreased, so as to prevent a deterioration of an efficiency due to the difference of locations of a bobbin in an actuator and increase an efficiency of the light beam incident from light sources.

2. Description of the Related Art

Nowadays, there is a tendency that recording media are changed from tapes to discs because data to be recorded are usually digital data and the size of the data becomes bigger and bigger. In addition, it is also a tendency that the recording density of the data on the discs is increased so as to enlarge the storage capacity of the discs. Accordingly, instead of the compact disc (CD) appropriate for laser diodes having wavelengths of 780 nm, recently developed have been discs appropriate for laser diodes having wavelengths of 650 nm and 400 nm as light sources, so that the disc has a larger capacity. Consequently, an optical pickup, which functions to record and reproduce information on and from the above-mentioned discs, has been variously developed to have the downward compatibility so that the optical pickup can function on both of the discs having different storage densities.

FIG. 1 is a schematic constructional view of a conventional optical pickup, which includes two light sources of different wavelengths and a conventional numerical aperture adjusting means.

Referring to FIG. 1, a light beam emitted from a first light source 110 is transmitted through a collimator lens 130. In this case, the light beam having passed through the collimator lens 130 becomes a parallel light beam, and a numerical aperture of the light beam is adjusted by a numerical aperture adjusting means 140. Then, the light beam is focused on a disc 160 by an objective lens 150. In this case, the numerical aperture adjusting means 140 selectively transmits/reflects a light beam of a specific wavelength, so as to adjust the numerical aperture of the light beam.

In the meantime, a light beam emitted from a second light source 120, which has a wavelength different from that of the first light source 110, passes through the collimator lens 130 and goes on diverging to constitute a finite optical system. This is because the second light source 120 is located within the focal distance of the collimator lens 130.

Further, after the light beam passes through the collimator lens 130, the numerical aperture of the light beam is selectively adjusted by the numerical aperture adjusting means 140, and then the light beam is focused on the disc 160 by the objective lens 150. In this case, a spot of the disc 160, on which the light beam is focused, is changed according to a change of the location of the second light source.

Meanwhile, the light beam, which is incident to the objective lens 150 from the second light source 120, is not a parallel beam. Therefore, a radial movement of the objective lens 150, a movement in a direction perpendicular to the progressing direction of the light beam, has a large influence on the optical characteristic of the light beam focused on the disc 160.

In the meantime, in order to focus the light beam on the optimized spot on the disc 160, the focusing of the light beam on the disc 160 is adjusted by adjusting the location of the objective lens 150 together with the location of the second light source 120.

In this case, according to the kinds of the discs 160 on which the light beam is focused, the working distance between the objective lens 150 and the disc 160 makes a difference, which imposes an instrumental restriction in designing the optical pickups. FIG. 2 shows such a difference of the working distance as described above. That is, FIG. 2 is a schematic constructional view of an objective lens 210 and a disc 220 in the conventional optical pickup, for showing the difference of the working distance according to the kinds of the discs when the location of the objective lens 210 is adjusted to exactly focus the light beam on the discs 220 of different kinds.

Meanwhile, in the case where the difference of the working distance is larger than a predetermined value, the actuator is subject to a mechanical restriction, and a run-out in a direction of the focus, which may be generated by errors of the turntable, the disc, and so on during the reproduction/recording, can not be properly dealt with. Further, due to a shift of the location of the bobbin according to the above-mentioned difference of the location of the objective lens 210, the reference locations of the tracking coil and the focus in the magnetic circuit change, so that the operation characteristic of the actuator is deteriorated.

In the meantime, FIG. 3 is a schematic constructional view of a conventional optical pickup having a diffraction optical element.

Referring to FIG. 3, a light beam emitted from a first light source 310 is transmitted through a beam splitter 330 and then incident to a phase plate 340. Meanwhile, the phase plate 340 may be realized by means of, for example, a liquid crystal, in which case the voltage applied to the liquid crystal phase plate 340 can be adjusted so as to change the polarization state of the light beam incident to the liquid crystal phase plate 340, so that the light beam can be transmitted through the liquid crystal phase plate 340.

Thereafter, the light beam having passed through the phase plate 340 passes through a collimator lens 350. In this case, the light beam becomes a parallel light beam by passing through the collimator lens 350. Then, the light beam passes through a diffraction optical element 360 of a kinoform profile and an objective lens 370, and then is focused on a disc 380.

In this case, the diffraction optical element 360 is operated together with the phase plate 340 and diffracts the polarized beam, which has passed through the phase plate 340, in a predetermined direction according to the polarized direction of the light beam, so as to adjust the focused spot of the light beam according to the kind of the disc 380.

In the meantime, a light beam emitted from a second light source 320, which has a wavelength different from that of the first light source 310, is reflected by the beam splitter 330 and then is incident to the phase plate 340. Thereafter, the light beam having passed through the phase plate 340 passes through the collimator lens 350. In this case, the light beam becomes a parallel beam by passing through the collimator lens 350. Then, the light beam passes through the diffraction optical element 360 and the objective lens 370 and then is focused on the disc 380.

In the case where the diffraction optical element 360 as described above is utilized in selecting a light beam incident to the objective lens 370 according to the kind of the disc 380, the light beam emitted from the light source is not entirely condensed during the diffraction, so that the efficiency of utilization of the light is deteriorated.

In addition, this problem is less severe in the case of the reproduction system. However, in the case of the recording system, especially a high-multiple speed recording system, such deterioration of the efficiency in utilizing the light consequently requires a light source of higher power, to thereby reduce the number of optional elements of the optical pickup, which can be chosen by a user, or increase the manufacturing cost of the optical pickup.

### SUMMARY OF THE INVENTION

Accordingly, the present invention has been made in an effort to solve the problems occurring in the related art, and it is an object of the present invention to provide an optical pickup having an optical path difference adjusting unit, which enables data to be reproduced/recorded from/on discs of different kinds having different thicknesses by means of a single optical pickup, and in which a phase distribution of an adjusted light beam with respect to an incident light beam has a phase characteristic similar to that in a case where a diverging light beam is incident to an objective lens, so that an aberration of the light beam focused on the disc can be compensated.

Further, it is another object of the present invention to provide an optical pickup having an optical path difference adjusting unit, in which a difference of working distance from an objective lens to discs of different kinds is decreased, so as to prevent a deterioration of an efficiency due to the difference of locations of a bobbin in an actuator and increase an efficiency of the light beam incident from light sources.

In accordance with one aspect of the present invention, there is provided an optical path difference compensation means of a birefringence material: Which transmits incident lights having different wavelength and compensates a phase of the incident light to decrease aberration of one of said incident lights without affecting the other incident light.

In this case, the compensated incident light has a longer wavelength than the other. Further, the incident light are polarized light.

In accordance with another aspect of the present invention, there is provided an optical path difference compensation means made of a material: which has different refractive index for a light of one wavelength and transmits incident lights having different wavelength and compensates a phase of the incident light to decrease aberration of one of said incident lights without affecting the other incident light.

In this case, the compensated incident light has a longer wavelength than the other. Further the incident light are polarized light.

In accordance with another aspect of the present invention, there is provided an optical system including: an optical path difference compensation means made of a birefringence material; which transmits incident lights having different wavelength and compensates a phase of the incident light to decrease aberration of one of said incident lights without affecting the other incident light, and an objective lens for focusing thus compensated light onto a focal spot.

In this case, the compensated incident light has a longer wavelength than the other. Further, the incident light are polarized light.

Further, the compensation means and said objective lens are formed to maintain fixed distance therebetween.

In accordance with another aspect of the present invention, there is provided an optical pickup including: light sources for respectively emitting a light beam; an optical path difference compensation means made of a birefringence material, which transmits incident lights having different wavelength and compensates a phase of the incident light to decrease aberration of one of said incident lights without affecting the other incident light; and an objective lens for focusing thus compensated light onto a focal spot.

In this case, the compensated incident light has a longer wavelength than the other. Further, the incident light are polarized light.

Further, the compensation means and said objective lens are formed to maintain fixed distance therebetween.

Further, the compensation means and said objective lens are coupled in one body.

### BRIEF DESCRIPTION OF THE DRAWINGS

The above objects, and other features and advantages of the present invention will become more apparent after a reading of the following detailed description when taken in conjunction with the drawings, in which:

FIG. 1 is a schematic constructional view of a conventional optical pickup, which includes two light sources of different wavelengths and a conventional numerical aperture adjusting means;

FIG. 2 is a schematic constructional view of an objective lens and a disc in the conventional optical pickup, for showing the difference of the working distance according to the kinds of the discs when the location of the objective lens is adjusted to exactly focus the light beam on the discs of different kinds;

FIG. 3 is a schematic constructional view of a conventional optical pickup having a diffraction optical element;

FIG. 4 is a schematic constructional view of an optical pickup having an optical path difference adjusting means according to the present invention;

FIGS. 5a to 5c are phase-distribution graphs of the light beam for showing examples of the phase-changes of the light beam by the optical path difference adjusting means in the optical pickup as shown in FIG. 4;

FIG. 6 is a constructional view of a conventional optical pickup, including several phase-distribution graphs for describing the phase compensation principle when the light beam is focused on a disc in the conventional finite optical system;

FIG. 7 is a constructional view of an optical pickup having an optical path difference adjusting means according to the present invention, including several phase-distribution graphs for describing the phase compensation principle when the light beam is focused on a disc through the optical path difference adjusting means;

FIG. 8 is a graph for showing an example of phase distributions generated by an optical path difference adjusting means of an optical pickup according to the present invention, in the case where the light beam is focused on a disc by means of the optical path difference adjusting means; and

FIG. 9 is a view for showing the principle of compensating the phase in the case where the light beam is focused on different discs by means of the optical path difference adjusting means in the optical pickup according to the present invention.

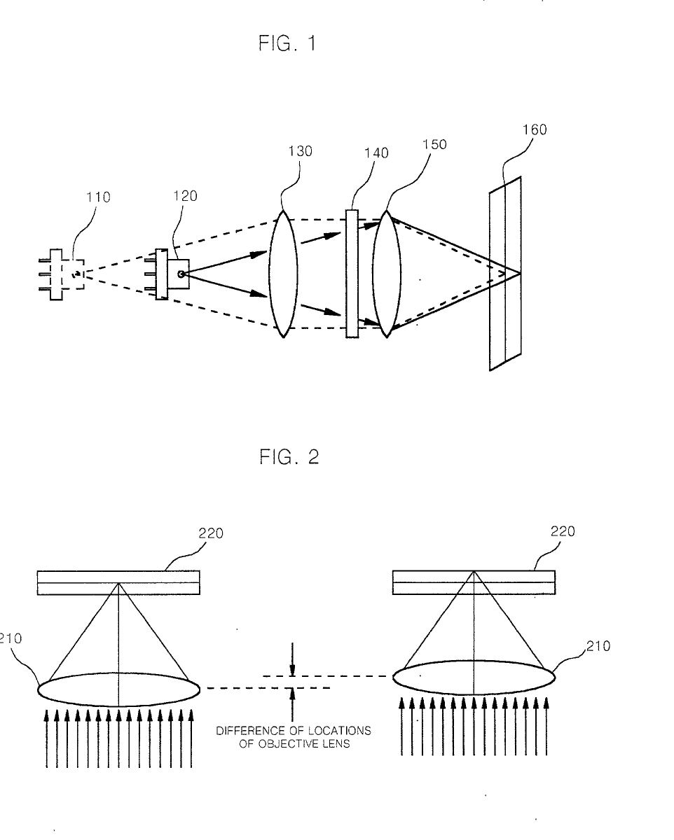

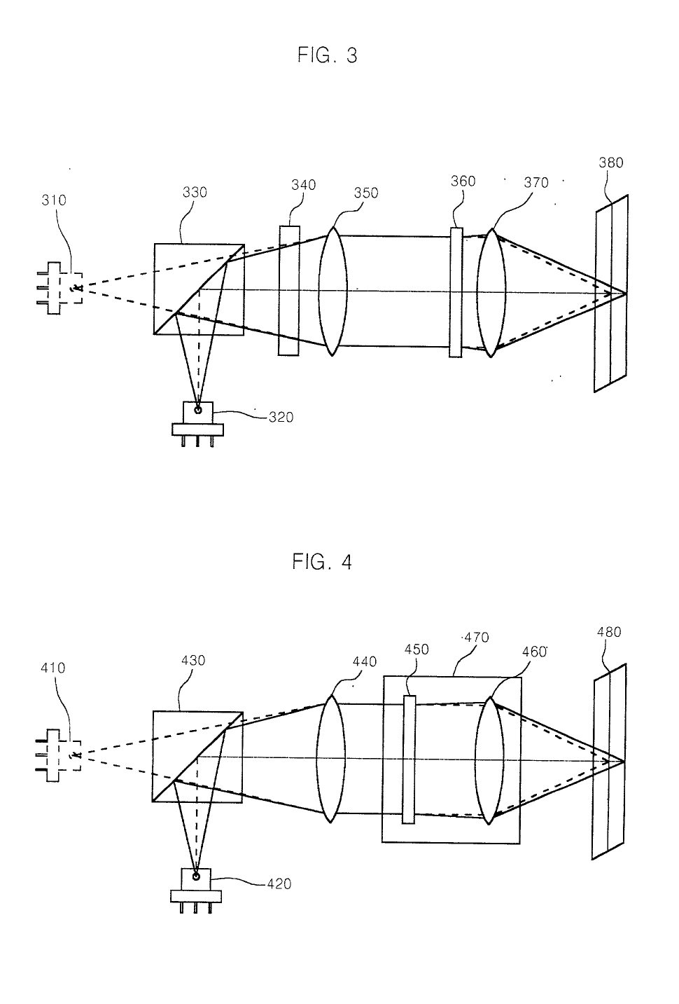

### DETAILED DESCRIPTION OF PREFERRED EMBODIMENTS

The above and other objects, characteristics, and advantages of the present invention will become apparent from the following description with reference to the accompanying drawings.

Referring to FIG. 4, which is a schematic constructional view of an optical pickup having an optical path difference adjusting means according to the present invention, the optical pickup includes light sources 410 and 420 for respectively emitting a light beam to record/reproduce data on/from a loaded disc 480, a collimator lens 440 for making the light beam emitted from the light sources 410 and 420 be transmitted in the form of a parallel beam, a beam splitter 430 for transmitting or reflecting the light beam emitted from the light sources 410 and 420 toward the collimator lens 440, an optical path difference adjusting means 450 for adjusting an optical path difference of the parallel light beam from the collimator lens 440 and then transmitting the light beam whose optical path difference is adjusted, and an objective lens 460 for focusing the light beam from the optical path difference adjusting means 450 on the disc 480. In this case, the optical path difference adjusting means 450 and the objective lens 460 constitute an actuator 470.

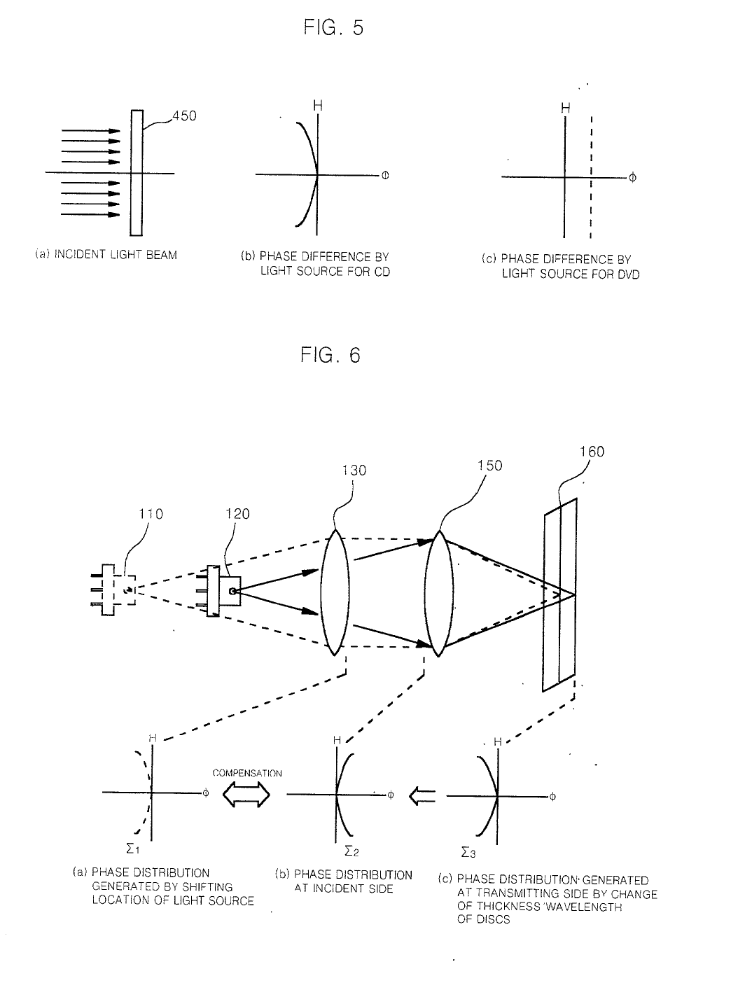

Hereinafter, the function of the optical path difference adjusting means 450 in the optical system having the above-described construction will be described with reference to FIGS. 5a to 5c, which are phase-distribution graphs for showing examples of the phase-changes of the light beam by the optical path difference adjusting means in the optical pickup as shown in FIG. 4.

Referring to FIGS. 4 and 5a to 5c, the parallel beam from the collimator lens 440 is incident to the optical path difference adjusting means 450. In this case, the following description will be given based on the case where the above-described optical system reproduces/records data from/on two different kinds of discs such as a compact disc (CD) and a digital versatile disc (DVD).

In the meantime, with respect to the parallel beam incident in the form as shown in FIG. 5a, the optical path difference adjusting means 450 transforms the parallel beam into a light beam having phase differences as shown in FIG. 5b when the parallel beam is emitted from the light source 420 for CD, while maintaining the parallel form of the beam having the same phase as shown in FIG. 5c when the beam is emitted from the light source 410 for DVD. As described above, the optical path difference adjusting means 450 changes the phase difference of the transmitting light beam according to the kind of discs on which the light beam is focused, so as to compensate the aberration of the light beam focused on the disc.

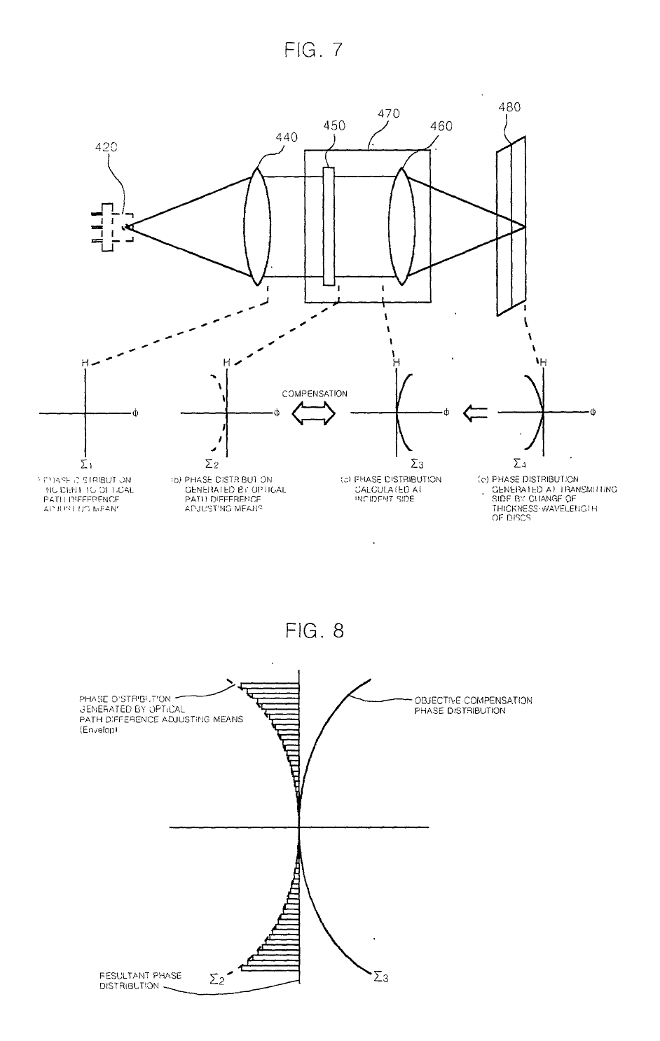

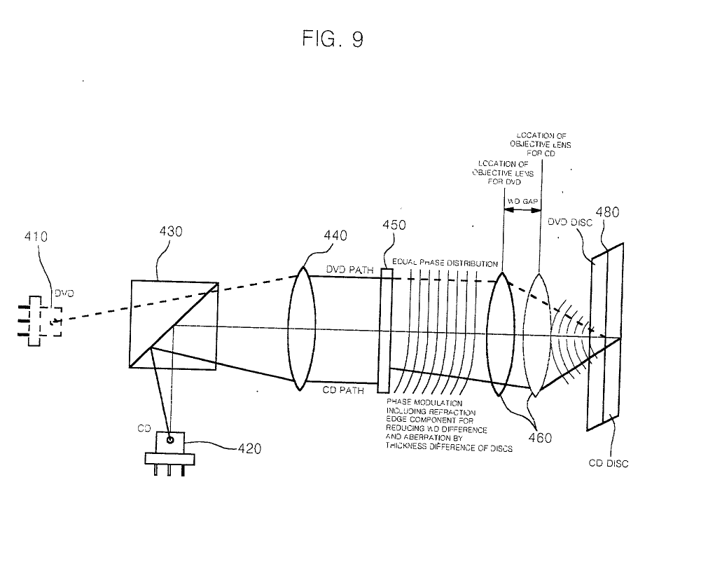

Hereinafter, a principle of compensating the aberration of the light beam focused on the disc by means of the optical path difference adjusting means 450 will be described with reference to FIGS. 6 and 7. FIG. 6 is a constructional view of a conventional optical pickup, including several phase-distribution graphs for describing the phase compensation principle when the light beam is focused on a disc in the conventional finite optical system, while FIG. 7 is a constructional view of an optical pickup having an optical path difference adjusting means according to the present invention, including several phase-distribution graphs for describing the phase compensation principle when the light beam is focused on a disc through the optical path difference adjusting means.

First, the phase compensation principle when the light beam is focused on a disc in the conventional finite optical system will be described hereinbelow with reference to FIG. 6. In the method where the downward compatibility is ensured by the finite optical system by means of the shift of locations of light sources 110 and 120 as shown in FIG. 6, the objective lens 150 designed for DVD is utilized to constitute both the optical system for DVD and the optical system for CD. In this case, when the thickness of the disc 160 on which the light beam is focused is changed so that the compact disc is reproduced/recorded, the thickness difference between the two different discs 160 generates an aberration.

Further, in the case where the light sources 110 and 120 of at least two kinds having different wavelengths are separately installed and used, an additional aberration according to the change of the wavelength, which is a kind of chromatic aberration, is generated, so as to deteriorate the performance of the optical pickup.

Meanwhile, let us trace the light beam having the above aberration in an adverse direction while changing the distance from an information recording surface of the disc 160 to the objective lens 150 on an assumption that the light beam is adversely transmitted from the disc 160 to the light sources 110 and 120. Then, with respect to the distance between any disc 160 and the objective lens 150, obtained is a location of a light source, at which the spherical aberration as described above is compensated by the phase distribution generated when the light beam emitted from the light source passes through the collimator lens 130.

That is, obtained is a location of a light source, at which the wave surface shown in the graph a of FIG. 6 has the same shape as that of the wave surface shown in the graph b of FIG. 6. In this case, the light beam focused on the disc 160 has an optimized quality of light. In the meantime, the graph c of FIG. 6 shows a phase distribution of the light beam formed at the transmitting side of the objective lens 150 with respect to the change in the wavelengths of the light sources 110 and 120 and the thickness of the disc 160. Therefore, in the case of the CD reproducing/recording system, the location of the second light source 120 for reproducing/recording the CD is moved to the location of the above optimum performance, so as to compensate the aberration generated from the light beam focused on the disc 160 for CD.

In this method, the location of the second light source 120 is shifted to change the optical path, so that the light beam passing through the collimator lens 130 becomes a diverging beam due to the refraction characteristic of the collimator lens 130, which achieves a phase necessary for compensating the aberration.

Hereinafter, described with reference to FIG. 7 will be a principle of compensating the aberration of the light beam focused on a disc by means of the optical path difference adjusting means 450 in an optical pickup having the optical path difference adjusting means 450 according to the present invention.

Referring to FIG. 7, in the case where the disc 480 for CD is reproduced/recorded by means of the objective lens 460 for DVD, a wave surface aberration generated by the change of the wavelength and the thickness of the disc 480 as shown by graph d in FIG. 7 is taken into consideration, likewise in the construction of the conventional finite optical system utilizing the change of the light source. Moreover, from a magnification condition by which the above wave surface aberration as shown by graph d in FIG. 7 can be compensated, a phase distribution at the incidence side of the objective lens 460 is calculated through a tracing of the light beam in an adverse direction, so as to set a so-called objective compensation wave surface capable of compensating the phase distribution (see graph c in FIG. 7).

In this case, the phase distribution of the aberration of the objective compensation wave surface can be expressed in the form of a second order function with respect to the radial direction, which is a direction perpendicular to the progressing direction of the light beam. In order to compensate this phase, the optical path difference adjusting means 450 is constructed in such a manner as to generate a phase distribution having the same magnitude and the opposite sign with respect to the r value in the radial direction and the objective compensation phase of the parallel beam incident with the same phase as shown by graph a in FIG. 7.

In this case, the phase distribution generated from the optical path difference adjusting means 450 can be expressed by the following phase equation,

Φ(r)=(2π/π)Ar²,

in which A is a coefficient and constant terms are omitted. By putting a value into A in the above equation, the objective compensation phase distribution and the phase distribution of the opposite sign as shown by graph b in FIG. 7 can be obtained. In this way, the aberration due to the change of the wavelength and the thickness of the disc 480 can be compensated, similarly to the conventional finite optical system by means of a change of the location of the light source. That is, the phase difference of the light beam transmitting through the optical path difference adjusting means 450 has a predetermined phase distribution according to the height of the light beam from the light-axis, which phase distribution is rotationally symmetric.

Hereinafter, a method of generating a phase distribution by means of the optical path difference adjusting means 450 will be described with reference to FIG. 8, which is a graph for showing an example of phase distributions generated by the optical path difference adjusting means 450 in the case where the light beam is focused on a disc by means of the optical path difference adjusting means in an optical pickup according to the present invention.

In manufacturing a real optical path difference adjusting means 450, it is difficult to obtain a continuous phase distribution as expressed by the above equation. Therefore, the area of the optical path difference adjusting means 450 is concentrically divided in the radial direction into sectors as shown in FIG. 8. Further, in the case of the compact disc (CD), the index of refraction, the thickness, and so forth of a medium are adjusted in such a manner as to generate discontinuous phase differences according to the respective sectors with respect to the radial direction.

Further, the widths of the sectors are decreased, so that a phase function presented by an enveloping curve connecting the respective sectors has a distribution whose sign and magnitude are respectively opposite and equal to those of the objective compensation phase distribution.

In this case, the index of refraction, the thickness, and so forth of the medium constituting the optical path difference adjusting means 450 are adjusted. In the meantime, in the case of the digital versatile disc (DVD), it should be taken into consideration in determining the index of refraction or the thickness of the medium that the phase with respect to the path difference for each sector fulfills the following same condition, that is,

2πn+Φ,

in which n is an integer, even though the sectors respectively have a physically different optical thickness for the wavelength, the polarization, and so forth. Further, through this way, in the case of reproducing/recording data from/on the DVD, the phase of the light beam incident to the objective lens 460 becomes the same phase, so as to achieve a superior reproduction/recording characteristic of DVD without a change in the optical performance.

Further, a material of birefringence may be employed in the optical path difference adjusting means 450 in the case where the optical path difference adjusting means 450 is designed to utilize different polarizations. Moreover, since the wavelength, the polarization, and so forth may be utilized as design references as described above, an effective phase compensation can be carried out regardless of whether a plurality of light sources are separately installed or a single light source is employed.

Furthermore, even without a refraction or a diffraction of the light beam by means of an optical element, an optical path difference is generated by the optical path difference adjusting means 450 as described above, so that the light beam can be a diverging beam according to Huygens' principle, in which the light beam is propagated in a direction perpendicular to the wave surface. Therefore, the phase compensation can be achieved, identically with the case in which the light beam transmitting through the collimator lens 440 becomes a diverging beam by changing the location of the light source and suchlike.

Meanwhile, FIG. 9 is a view for showing the principle of compensating the phase in the case where the light beam is focused on different discs by means of the optical path difference adjusting means in the optical pickup according to the present invention.

By an optical pickup having an optical path difference adjusting means according to the present invention as described above, not only data can be reproduced/recorded from/on discs of different kinds respectively having a different thickness by means of a single optical pickup, but also the phase distribution of the light beam adjusted with respect to the incident light beam has a phase characteristic similar to that in the case where a diverging light beam is incident to the objective lens, so that the aberration of the light beam focused on the disc can be compensated. Further, the difference of the working distance from the objective lens to the discs of different kinds can be reduced, so that the optical pickup can be minified and a change in the performance of the actuator can be reduced.

In addition, the phase modulation as described above can be realized by means of the thickness difference of the medium having a certain index of refraction without utilizing a diffraction optical element, so that the light beam emitted from the light source can be entirely utilized to thereby improve the optical efficiency, which characteristic is advantageous for a recording optical pickup. Moreover, in the present invention, an optimum performance can be achieved for each of the discs of different types, so as to prevent an optical noise from being generated.

Further, since the light beam incident to the objective lens is a parallel beam, even a change of the location of the objective lens in the radial direction of the disc has little influence on the optical characteristic of the light beam focused on the disc.

While there have been illustrated and described what are considered to be preferred specific embodiments of the present invention, it will be understood by those skilled in the art that the present invention is not limited to the specific embodiments thereof, and various changes and modifications and equivalents may be substituted for elements thereof without departing from the true scope of the present invention.

What is claimed is:

1. An optical path difference compensation means of a birefringence material:
Which transmits incident lights having different wavelength and compensates a phase of the incident light to decrease aberration of one of said incident lights without affecting the other incident light.

2. In claim 1, wherein said compensated incident light has a longer wavelength than the other.

3. In claim 1, wherein said incident light are polarized light.

4. An optical path difference compensation means made of a material:
which has different refractive index for a light of one wavelength and transmits incident lights having different wavelength and compensates a phase of the incident light to decrease aberration of one of said incident lights without affecting the other incident light.

5. In claim 4, wherein said compensated incident light has a longer wavelength than the other.

6. In claim 4, wherein said incident light are polarized light.

7. An optical system including:
an optical path difference compensation means made of a birefringence material; which transmits incident lights having different wavelength and compensates a phase of the incident light to decrease aberration of one of said incident lights without affecting the other incident light, and
an objective lens for focusing thus compensated light onto a focal spot.

8. In claim 7, wherein said compensated incident light has a longer wavelength than the other.

9. In claim 7, wherein said incident light are polarized light.

10. In claim 7, said compensation means and said objective lens are formed to maintain fixed distance therebetween.

11. An optical pickup including:
light sources for respectively emitting a light beam;
an optical path difference compensation means made of a birefringence material; which transmits incident lights having different wavelength and compensates a phase of the incident light to decrease aberration of one of said incident lights without affecting the other incident light; and
an objective lens for focusing thus compensated light onto a focal spot.

12. In claim 11, wherein said compensated incident light has a longer wavelength than the other.

13. In claim 11, wherein said incident light are polarized light.

14. In claim 11, said compensation means and said objective lens are formed to maintain fixed distance therebetween.

15. In claim 11, said compensation means and said objective lens are coupled in one body.
